(19) United States
(12) Patent Application Publication
(10) Pub. No.: US 2022/0392032 A1
(43) Pub. Date: Dec. 8, 2022

(54) CLASSIFICATION-BASED IMAGE MERGING, TUNING, CORRECTION, AND REPLACEMENT

(71) Applicant: f8 Real Estate Media, LLC, Los Altos, CA (US)

(72) Inventors: Satya Mallick, San Jose, CA (US); Gurismar Singh, Bengaluru (IN); Pranav Mishra, Bengaluru (IN); Sowjana Konduri, Bengaluru (IN); Sunita Nayak, San Diego, CA (US); Steve Elich, San Jose, CA (US); William Botero, San Jose, CA (US); Ryan Ozubko, San Jose, CA (US)

(21) Appl. No.: 17/337,175

(22) Filed: Jun. 2, 2021

(51) Int. Cl. G06T 5/50; G06T 5/00; G06T 7/90; G06T 7/11; G06T 7/136; G06T 7/155; G06T 7/194; G06V 10/764; G06V 10/82

(52) U.S. Cl. CPC G06T 5/50; G06T 5/009; G06T 5/002; G06T 7/90; G06T 7/11; G06T 7/136; G06T 7/155; G06T 7/194; G06V 10/764; G06V 10/82; G06T 5/005; G06T 2207/20221; G06T 2207/20208; G06T 2207/20016; G06T 2207/20036; G06T 2207/20084; G06T 2207/20081

(57) ABSTRACT

Methods for improving and modifying a High Dynamic Range (HDR) scene, captured as a series of images of the scene with different exposure levels and the scene through classification-based image merging, tuning, correction, and replacement. The approach employs mixing images to improve the selection and display of both shadowed and highlighted details. The increased efficiency resulting from improvements in computational resource utilization of image processing hardware can, from the implementation of the improved computational methods herein, significantly reduce the time required to generate and display a tone-mapped HDR image, a gamma-corrected HDR image, and/or a segmented and replaced HDR image.

### FIELD OF THE INVENTION

Embodiments of the present invention generally relate to merging multiple images of a scene to generate a tuned, corrected, and/or altered final scene image.

### DESCRIPTION OF THE RELATED ART

Images captured by digital cameras are formed from pixels, and every pixel has a limited number of digital bits per color. The number of digital bits per pixel is called the pixel bit width value or pixel depth value. A High Dynamic Range (HDR) image has pixel bit width values greater than 8 bits, which means more information can be provided per pixel, thus affording greater image contrast and detail. HDR images can thus provide more complete gradients of gray shades, and improved clarity in an image's shadows, highlights and mid tone regions that would be missing from standard low dynamic range (LDR) images.

An HDR image can be captured by rapidly acquiring multiple LDR images of a scene that are captured at different exposure levels. There are a variety of scenarios that present unique challenges in generating HDR images, including low light levels, high noise, and high dynamic range situations. The dynamic range in an imaging situation refers to the range of luminance values in the scene to be imaged. It can be expressed as the ratio of the greatest luminance value in the scene to the smallest luminance value in the scene. Luminance values are dictated by the imaging exposure level of the scene. A low exposure level will properly capture the gray shades in scene areas fully illuminated by bright sunlight and a high exposure level will properly capture the gray shades in scene areas completely shielded from the sun and sky by buildings and trees. However, at the low exposure level the areas of the scene in shadow will be completely black, in black saturation, and show no detail, and the mid-tone areas will lose detail. Further, at the high exposure level, the highlights of the scene will be completely white, in white saturation, and show no detail, and the mid-tone areas will again lose detail. Thus, a third, mid exposure level image, which properly captures mid-level gray shades, is often acquired as well. By mixing these three LDR images, an HDR image can be generated that depicts an enlarged gray scale range of the scene. Merging multiple exposures preserves both the saturated and the shadow regions and thus provides a higher dynamic range than a single exposure. Most imaging systems are not capable of acquiring or capturing an HDR image with a single exposure. Thus, HDR images are typically computer-generated or generated from a combination of images captured at different times or with different exposure settings.

There are several known techniques for generating an HDR image from two or more exposures. In one technique, the exposures may be spatially interleaved. In some techniques, the imaging system merges multiple exposures and provides a native HDR Bayer image with a pixel bit width ranging from 12 to 20 bits. In some techniques, the imaging system captures multiple temporally spaced exposures and these exposures are merged to form an HDR image in the imaging device receiving the multiple exposures. Whether the imaging system generates the HDR image or the imaging device generates the HDR image, tone mapping may need to be performed on the HDR image to permit processing of the HDR image in an imaging pipeline with a lesser pixel bit width value, e.g., 10 to 12 bits.

Once an HDR image has been created, it can be challenging to then display that image properly in an electronic or printed medium, because the electronic or print medium itself lacks dynamic range. This challenge is typically addressed with tone mapping operators (TMOs), which convert a range of luminance values in an input image into a range of luminance values that well matches the electronic or pre-print medium. Although known, current tone mapping methodologies require significant processing operations requiring the performance of a large number of floating point operations over a short period of time. Thus, there is a need to provide techniques and algorithms for improved tone mapping and for improved generation of HDR tuned images without this significant computational burden.

Even following the creation of a properly-tuned HDR image, certain professions or marketplace segments require that images be further corrected and/or have segments replaced entirely with alternative imaging material. One example is the field of real estate photography, which requires that exterior property photographs collected during a particular time of day, and during certain weather, be corrected and/or modified to present buyers with scenes of the property in differing contexts (e.g. exterior overcast shot versus sunny, removing image ghosting due to wind movement, etc.). HDR image classification, segmentation, and replacement methods exist to address the needs of these marketplace segments, however they present significant challenges from a lack of efficient automation in segmenting and replacing portions of images to produce acceptable scenes.

It is against this background that the techniques and algorithms described herein have been developed. To overcome the problems and limitations described above there is a need for an improved method of classification-based HDR image exposure merging, tuning, correction, and segment replacement.

### BRIEF SUMMARY OF THE INVENTION

One or more embodiments of the invention are directed a classification-based HDR image merging, tuning, correction, and/or replacement method.

The invention may be embodied as a method of mixing a plurality of digital images of a scene, including capturing the images at different exposure levels, registering counterpart pixels of each image to one another, deriving a normalized image exposure level for each image, and employing the normalized image exposure levels in an image blending process. The image blending process includes using the image blending process to blend a first selected image and a second selected image to generate an intermediate image, and when the plurality is composed of two images, outputting the intermediate image as a mixed output image. When the plurality is composed of more than two images, the image blending process includes repeating the image blending process using the previously generated intermediate image in place of the first selected image and another selected image in place of the second selected image until all images have been blended, and outputting the last generated intermediate image as the mixed output image.

The image blending process blends the counterpart pixels of two images and includes deriving a luma value for a pixel in the second selected image, using the luma value of a second selected image pixel as an index into a look-up table to obtain a weighting value between the numbers zero and unity, using the weighting value, the normalized exposure level of the second selected image, and the second selected image pixel to generate a processed second selected image pixel, selecting a first selected image pixel that corresponds to the second selected image pixel, using the first selected image pixel and the result of subtracting the weighting value from unity to generate a processed first selected image pixel, adding the processed first selected image pixel to the counterpart processed second selected image pixel to generate a blended image pixel, and repeating the above processing sequence until each second selected image pixel has been blended with its counterpart first selected image pixel.

The method may include determining gamma correction in an image by: receiving, by one or more processors, at least a first exposure image of a scene; receiving, by the one or more processors, at least a second exposure image of the scene, wherein the second exposure image of the scene has a shorter exposure time than the first exposure image of the scene; computing, by the one or more processors, a pixel value for a pixel location of a high dynamic range (HDR) image to be a sum of a pixel value of the first exposure image weighted by a first exposure weight and a pixel value of the second exposure image weighted by a second exposure weight, to produce a merged HDR image comprising Y bit data; adaptively mapping, by the one or more processors, the HDR image, to produce an output HDR image having Z bit data and a total number of pixels; applying, by the one or more processors, a range of gamma value correction levels to the output HDR image detecting a number of pixels having a value of black level less than a predefined black level threshold; and selecting a tuned gamma value correction level.

The method may include correcting detail obscured by brightness glare in an image, by: receiving, by one or more processors, at least a first exposure image of a scene; receiving, by the one or more processors, at least a second exposure image of the scene, wherein the second exposure image of the scene has a shorter exposure time than the first exposure image of the scene; computing, by the one or more processors, a refined mask, by performing a conjugation of the at least first exposure image of the scene and the at least second exposure image of the scene and selecting a number of pixels having a value of black level greater than a predefined black level threshold tb to form an unrefined mask of the scene, quantifying an amount of detail present in at least one portion of the second exposure image of the scene having a brightness level higher than the average brightness level of all pixels in the second exposure image of the scene, by applying a Laplacian to said second exposure image of the scene and applying a median blur denoising operation to form an intermediary laplacian mask, and selecting at least one pixel in at least one region of the intermediary laplacian mask that does not have a zero value; and computing a blended image by applying a gaussian pyramid operation and a Laplacian pyramid merging of the at least second exposure image and an exposure fusion image using the refined mask.

The method may also commence the image mixing prior to the capture of all the images of the plurality. The method may also commence the image mixing immediately after the capture of the second image of the plurality.

The method may include segmenting an image having sky in a scene, by computing a pixel mask as follows: receiving, by one or more processors, at least a first exposure image of a scene; receiving, by the one or more processors, at least a second exposure image of the scene, wherein the at least second exposure image of the scene has a shorter exposure time than the at least first exposure image of the scene; detecting, a number of pixels having a blue hue value greater than a predefined blue hue level threshold, greater than a red hue value for the number of pixels, and greater than a green hue value for the number of pixels; computing a detection mask by performing a linear combination of at least one mean blue hue mask and one threshold blue hue mask; and computing at least one group of pixels from the detection mask as sky, by detecting a largest group of pixels having a blue hue value greater than a predefined blue hue level threshold, greater than a red hue value for the number of pixels, and greater than a green hue value for the number of pixels in the detection mask, and designating pixels away from the largest group of pixels as ‘not sky.’

The embodiments may further include a method of removing location shifted replications of scene objects appearing in a mixed image generated by a digital image mixing process applied to a plurality of images acquired at different exposure levels and different times, with the images having their counterpart pixels registered to one another.

The method may detect local motion by determining an absolute luminosity variance between each pixel of the reference image and the comparison image to produce a difference image and identifying difference image regions having absolute luma variances exceeding a threshold. The selected images used as reference images may include the image with the lowest exposure level, the image with the highest exposure level, or any images with intermediate exposure levels. The images to be processed may be downscaled in luminance value before processing.

Another embodiment of the invention is a method for segmenting image patches patches, comprising applying a morphological erosion operation on a binary image of relevant pixels, applying a morphological close operation on the binary image, applying a labeling algorithm to distinguish different patches, and outputting patch descriptions. In this embodiment, the relevant pixels may share identified properties, that may include inconsistent luminosity values from at least one image comparison, and/or detected local motion.

In a further embodiment, a method is provided for selecting a replacement image from a plurality of candidate replacement images as a source for replacement patch image data. The method may include computing a weighted histogram of luma values of border area pixels of a particular patch of a reference image, dividing the histogram into a plurality of regions according to threshold values determined from relative exposure values of the candidate replacement images, calculating a score function for each histogram region, selecting the region with the maximum score, and outputting the corresponding candidate replacement image. The histogram weighting may increase the influence of over-saturated and under-saturated luma values. In this embodiment, candidate replacement images of relatively low exposure values may be selected for replacing patches from reference images of relatively high exposure values, and vice-versa. The reference image may be a medium exposure image with downscaled luma values. The score function for a particular histogram region may be defined as the ratio of the number of pixels in the particular histogram region considering the size of the particular histogram region, to the average difference of the histogram entries from the mode luma value for the particular histogram region.

Additionally, the invention may be embodied as a method for replacing patch image data in a composite image and blending the composite image and the upscaled smoothed patch image to produce an output image.

### BRIEF DESCRIPTION OF THE DRAWINGS

The above and other aspects, features and advantages of the invention will be more apparent from the following more particular description thereof, presented in conjunction with the following drawings wherein:

FIG. 1 is a flowchart illustrating the general process of merging, classifying, segmenting, and replacing portions of a scene within a blended HDR image, in part in accordance with one or more embodiments of the present invention.

FIG. 2 is a set of three images taken of a scene, where each of the three images has a different exposure level.

FIG. 3. is a set of two images taken of a scene, and an associated four-part grid demonstrating the composited alignment of the two images using a coarse-to-fine alignment schema.

FIG. 4 is a flowchart illustrating the process of creating a blended HDR image that captures heightened detail in brighter scene areas, in accordance with one or more embodiments of the present invention.

FIG. 5 is a demonstration of the process of creating an unrefined brightness mask by applying a thresholded logical conjunction of a highest and lowest exposure image of a scene, in accordance with one or more embodiments of the present invention.

FIG. 6 is a demonstration of the process of creating a refined brightness mask by conjugating an intermediary laplacian mask and the unrefined brightness mask, in accordance with one or more embodiments of the present invention.

FIG. 7 is a demonstration of the process of blending the lowest exposure image of a scene, the exposure fusion image of a scene, and the calculated refined brightness mask to form a finalized brightness-adjusted HDR image that captures heightened detail in brighter scene areas, in accordance with one or more embodiments of the present invention.

FIG. 8 is a set of two images taken of an exterior scene, where each of the two images has a different exposure level. (pg. 10)

FIG. 9A is a flowchart illustrating the process of segmenting the portion of pixels representing the sky from the same exterior scene captured in each of the two images, in accordance with one or more embodiments of the present invention.

FIG. 9B is a flowchart illustrating the process of segmenting the portion of pixels representing the sky from the same exterior scene captured in each of the two images, in accordance with one or more embodiments of the present invention.

FIG. 9C is a flowchart illustrating the process of segmenting the portion of pixels representing the sky from the same exterior scene captured in each of the two images, in accordance with one or more embodiments of the present invention.

FIG. 10 is a demonstration of the process of creating a detection mask to aid in segmenting the portion of the same exterior scene captured in each of the two images representing the sky, in accordance with one or more embodiments of the present invention.

FIG. 11 is a demonstration of the process of creating a combined detection mask to aid in segmenting the portion of the same exterior scene captured in each of the two images representing the sky, in accordance with one or more embodiments of the present invention.

FIG. 12 is a demonstration of the process of creating a value mask to aid in segmenting the portion of the same exterior scene captured in each of the two images representing the sky, in accordance with one or more embodiments of the present invention.

FIG. 13 is a demonstration of the process of creating a sure sky mask to aid in segmenting the portion of the same exterior scene captured in each of the two images representing the sky, in accordance with one or more embodiments of the present invention.

FIG. 14 is a demonstration of the process of creating a finalized sky segmentation mask that excludes all regions of the exterior scene captured in each of the two images that does not represent the sky, in accordance with one or more embodiments of the present invention.

FIG. 15 is a demonstration of replacing the portion of the exterior scene that represented the sky with another image.

### DETAILED DESCRIPTION

The present invention comprising classification-based image merging, tuning, correction, and replacement method will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, 10, and ranges in between” can include 1-1, 1-3, 2-10, etc. Similarly, “1, 5, 10, 25, 50, 70, 95, or ranges including and or spanning the aforementioned values” can include 1, 5, 10, 1-5, 1-10, 10-25, 10-95, 1-70, etc.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

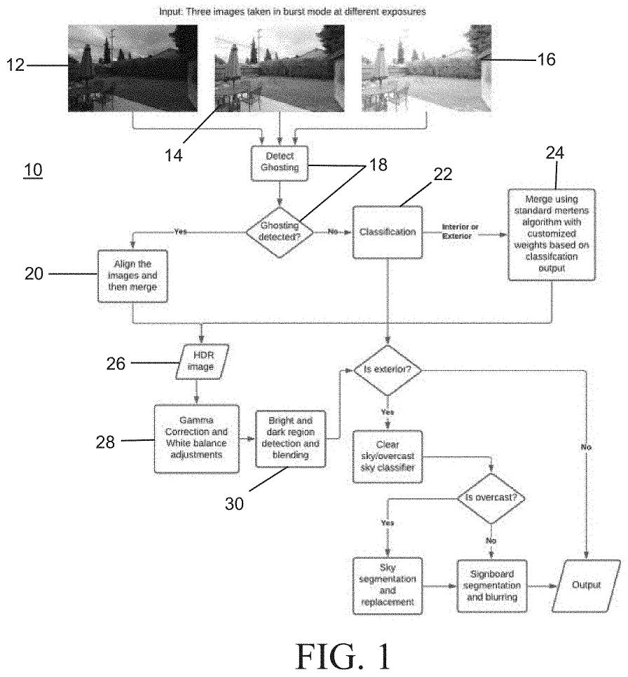

One or more embodiments of the present invention will now be described with references to FIGS. 1-15.

FIG. 1 provides a diagrammatic flowchart of a process that includes classification-based HDR image merging, tuning, correction, segmentation, and replacement. The HDR process 10 begins by collecting and identifying images of a particular scene, that each have different exposure times and thus different light levels. Here, three images are shown as the input, with the first being a low exposure darkest image 12, the second being a medium exposure medium darkness image 14, and the third being a high exposure brightest image 16. All of the images are merged to form a single HDR composite image of the scene, and then inspected for any ghosting effects 18 that may have appeared as a result of the merge.

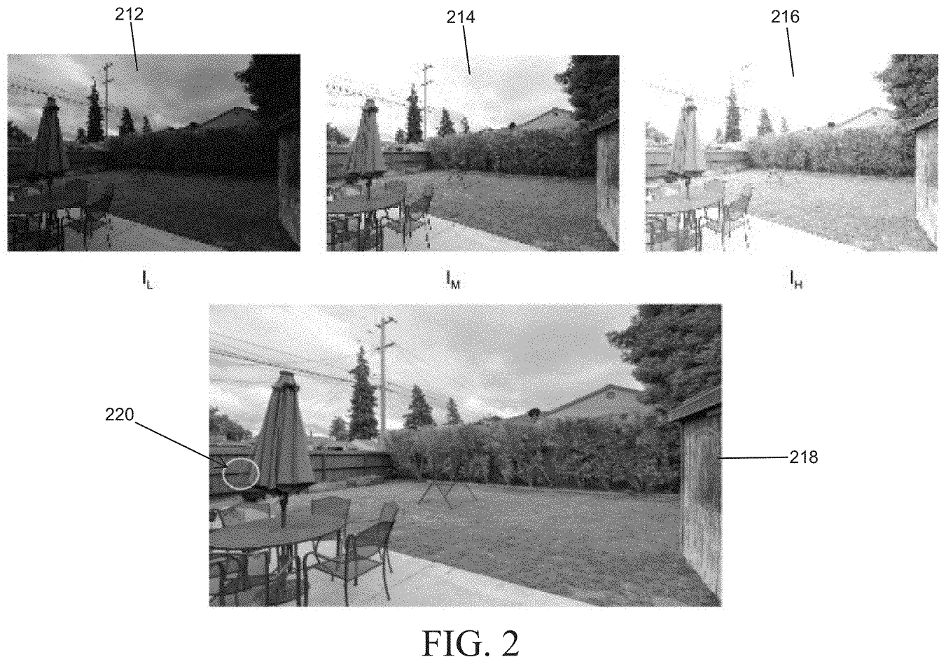

FIG. 2 shows a grey-scaled version of the low exposure darkest image 212 labeled as I_{L}, the second being a medium exposure medium darkness image 214 labeled as I_{M}, and the third being a high exposure brightest image 216 labeled as I_{H}, and a merged composite image 218 bearing an annotated exemplary ghosting region 220. When an object in a scene moves during the capture of three different exposure images 212, 214, and 216, after merging it can create a transparent “ghosting” region 220 around or within that object in the merged composite image 218. If there is no anomaly detected between a masked and thresholded comparison 18 of each of the different exposure images forming a composite image, then the brightness of each pixel should increase in correlation to its combined exposure duration, excepting only the brightest and darkest regions of the image. If not, then a ghosting detection process 18 will isolate the pixels comprising the anomalous transparent ghosted region 220, thus allowing for their later removal or correction.

In the first step of the ghosting detection process 18, the images are thresholded using two thresholds t_{d} and t_{b}, for each image 212, 214, and 216 where:

(I>t_{b} or I<t_{d})=>I=0

Where I represents that respective image's intensity or brightness.

In the second step, for each pixel's intensity in each respective image 212, 214, and 216 check for the following condition:

i_{H}ⁱ>I_{M}ⁱ>I_{L}ⁱ

where i is the pixel location, and I_{H}, I_{M}, I_{L} are the high 216, medium 214, and low 212 exposure images, respectively.

In the third step, create a binary mask, using the equation in step two, setting a mask pixel value to ‘1’ if condition is ‘false’, and setting a mask pixel value to ‘0’ if the condition is ‘true.’ The white pixels in the formulated binary black/white ghosting mask indicate the pixels in the merged composite image 218 that containing a ghosting region 220.

In the final step, filter for noise and count the number of non-zero pixels in the merged composite image 218. Finally, threshold this number of non-zero pixels by dividing it by total number of pixels in the image for ghosting:

If (N_{non zero} / Nₜₒₜₐₗ > threshold){
deghost = true
}

Referring again to FIG. 1, if ghosting is detected in a merged image following the application of the process 18 above, the pre-merged images 12, 14, and 16 must be aligned at local patch levels followed by a weighted merging process 20 before scrubbing the composite image 218 of the ghosting transparency region 220. For the alignment and merging process 20, the medium exposure medium darkness image 14 is used as the reference frame, although in a multi-image merging operation with even numbers, a reference frame should be selected as that which maintains a brightness, exposure, or intensity level between extremes.

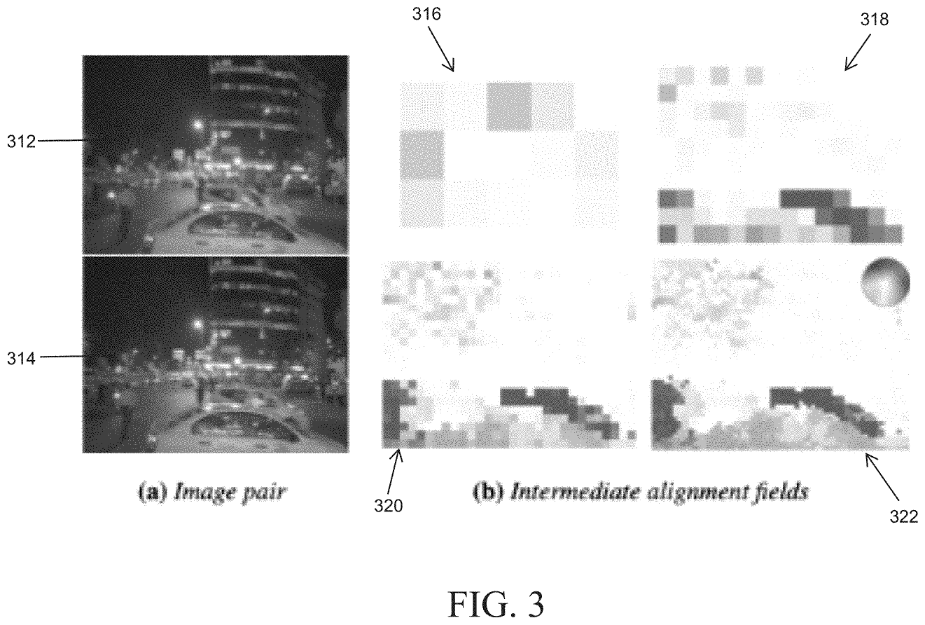

FIG. 3 shows two exterior images bearing extremes in exposure timing 312 and 314, where a medium darkness image of the same exterior scene has been set apart as a reference frame. To align the images, the extreme exposure exterior images 312 and 314 are aligned to the pre-selected reference frame by a coarse-to-fine alignment on four intermediate alignment fields 316, 318, 320, and 322 through the application of gaussian pyramids.

Each of the four alignment fields 316, 318, 320, and 322 is divided into segments, and each segment is matched with a corresponding candidate segment in an alternate image. The overall displacement in alignment is calculated from the sum of L1 distance between the pixel of the reference segment and the search area expanded by (4,4) in the alternate segment. This generates an aligned image set where for each segment, there are offset values determining which segment to choose while merging the images 312 and 314.

After aligning the images 312 and 314, they can be merged first temporally and then spatially. In the initial temporal merging step, each segment is first merged between burst images based on an offset determined by the alignment process described above. Weighting for selection of a segment is determined based on the average distance between pixel values of aligned segments.

The temporal phase of post-alignment merging follows the following equations:

O(x,yₜ)=Σⁱ⁼ⁿ(Wₜⁱ*Iₜⁱ(x,y)/Wₛ)+Iₜ^{t}(x,y)/Wₛ

Where,

Wᵣⁱ=1/NDₜⁱ if NDₜⁱ>290 else 0

NDᵣⁱ=max(1,Σ^{x=16,y=16}(Iₜⁱ(x,y)−Iᵣ(x,y))/256)

Wₛ=Σⁱ⁼³(Wₜ)

Where Iₜⁱ is the underlying intensity value of segment ‘t’ in the i^{th} exposure image and Iₜⁱ is the initially-segregated reference image.

Following the temporal merging of images, the temporally-merged segments are now merged spatially to create an aligned and deghosted composite HDR image 26 (FIG. 1). For smoothness, each segment is merged using a raised cosine window of the same size of that segment.

Referring again to FIG. 1, if ghosting is not detected in a merged image following the application of the process 18 above, the combined exposure-composite image is then scrutinized for automatic categorization tagging 24. The medium exposure medium darkness image 14 is used to classify the captured scene as relating to several categories. Here, the present embodiment relates to residential photography, and thus the scenes can be separated distinctly between interior and exterior scenes, as each class maintains distinct preferences for weighting contrast, saturation, and exposure of a final image. In an alternative embodiment, any applicable classification nomenclature may be adopted, and this process may be applied to any photographically-related discipline that relies upon HDR imagery. A combined ensemble of two inceptionV3 models with input size (684×342) is used to classify the medium exposure medium darkness image 14 into an AWB (Auto White Balance) image, or a category from the following classes relevant to the present embodiment:

{0: ‘BATHROOM’, 1: ‘BEDROOM’, 2: ‘CLOSET’, 3: ‘COMMON_AREA_ROOM’, 4:
‘DINING’, 5: ‘ENTRY_SHOT_FRONT_DOOR’, 6: ‘FRONT_EXTERIORS’, 7:
‘GARAGE’, 8: ‘HOA_COMMON_AREA_AMENITIES_EXTERIOR’, 9:
‘HOA_COMMON_AREA_AMENITIES_INTERIOR’, 10: ‘KITCHEN’, 11:
‘LAUNDRY’, 12: ‘REAR_EXTERIORS’, 13: ‘SPECIALTY’, 14: ‘STAIRS’, 15:
‘WHITE_BALANCE’}

The applied label is then used to select particular parameters and/or thresholds in later HDR image processing. Again, depending on the applicable context for image review and use, the classification labeling may differ from the above.

If ghosting was not detected following the application of the process 18 above, the images 12, 14, and 16 can be merged using a standard Mertens algorithm (via Exposure Fusion) 24, resulting in a manipulable HDR image 26. As part of the merge, the Exposure Fusion weights for contrast, saturation and exposure were determined by the classification 22 of the scene as being either interior or exterior.

To improve image quality, the merged output HDR image 26 from either the classification 22 and Exposure Fusion merge 24, or the deghosted alignment and merging process 20, is tuned using gamma corrections 28 followed by correcting dark and bright regions 30 in the scene.

In this embodiment related to residential photography, the tuning algorithm is different for ‘interior’ and ‘exterior’ scenes. In interior scenes, one goal is to not allow black levels below a certain threshold. With an HDR image 26 as a starting point, the HDR image 26 can be adaptively mapped to produce an output HDR image having ‘Z’ bit data and a total number of pixels Nₜₒₜₐₗ. A range of gamma values from 0.5 to 2.0 are then applied to alter the image 26, the number of pixels (N_{b}) with values less than a black level threshold (t_{b}) is determined, and then the lowest tuned gamma value correction level is selected, for which:

N_{b}<0.025*(Nₜ)

where Nₜ is the total number of pixels.

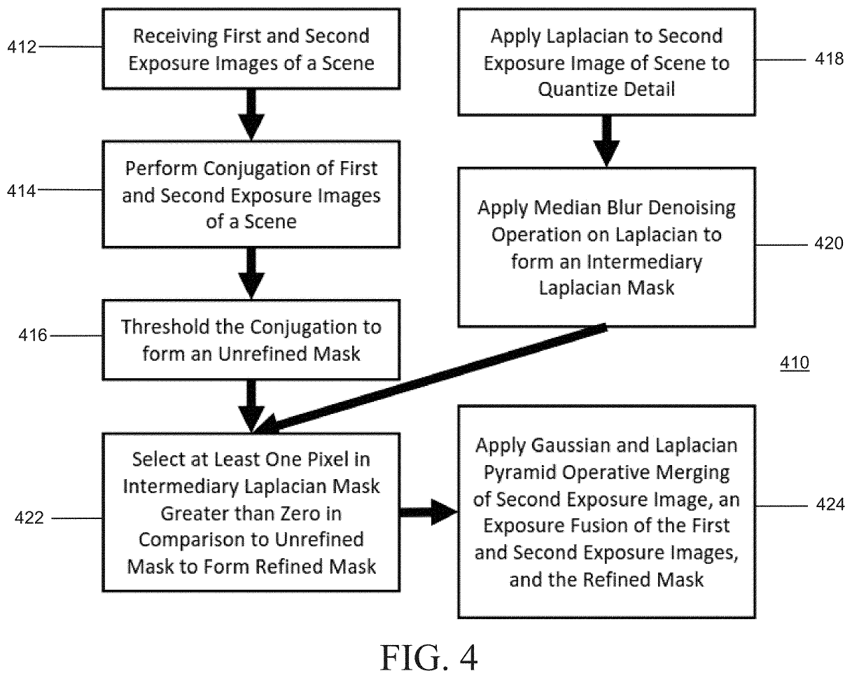

Further, interior scenes often include significant glare in brighter pixel regions, thus leading to an overall degradation of detail within brighter regions of the scene. To correct this, the omitted details are recovered from the lowest exposure image. FIGS. 4-7 illustrate the recovery of detail and correction of brightness within over-exposed regions of an HDR composite image 26 that is classified as relating to an ‘interior’ scene.

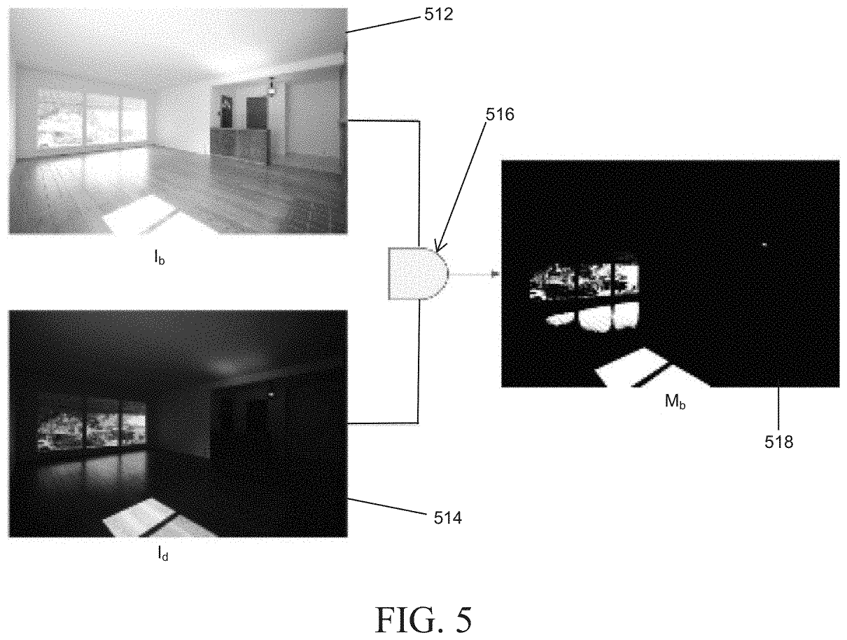

FIG. 4 provides a diagrammatic flowchart of a method for correcting detail obscured by brightness glare in an image 410. The first step is to receive or retrieve 412 at least a first exposure image of a scene 512 (FIG. 5) and at least a second exposure image of the scene 514 (FIG. 5), where the second exposure image of the scene 514 has a shorter exposure time than the first exposure image of the scene 512. The second step is computing 414 a unrefined mask M_{b} 518 (FIG. 5), by performing a conjugation 516 of the at least first exposure image of the scene 512 and the at least second exposure image of the scene 514. The next step is thresholding the conjugation 416 by selecting a number of pixels Nₘ having a value of black level greater than a predefined black level threshold t_{b} to form an unrefined mask M_{b} 518 (FIG. 5) of the scene, as follows:

M_{b}=AND(I_{b},I_{d})>t_{b}, where I_{b} is the brightest image and I_{d} is the darkest image.

FIG. 5 illustrates the thresholded conjugation 516 of a grey-scaled brighter (e.g. over-exposed) first exposure image I_{b} 512 and a darker (e.g. under-exposed) second exposure image I_{d} 514 to form an unrefined mask M_{b} 518.

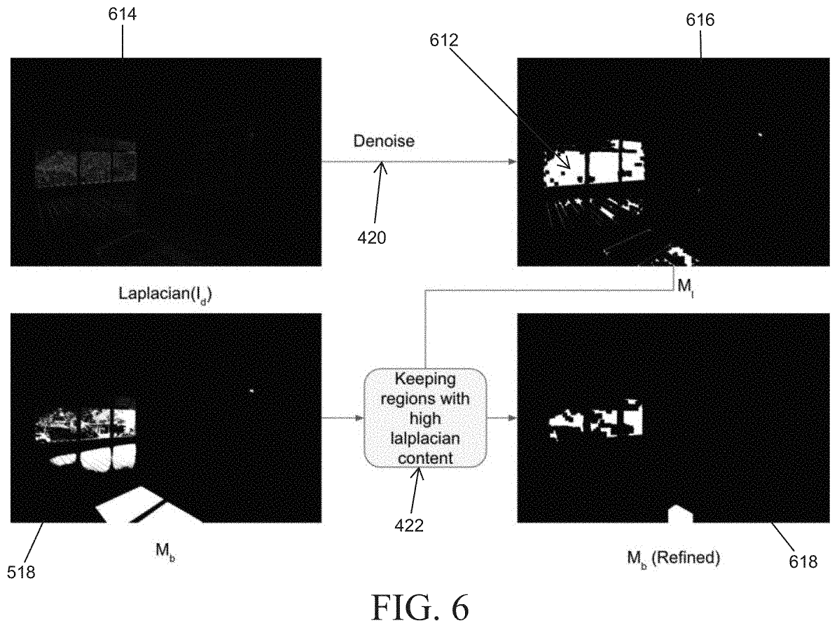

Referring again to FIG. 4, in conjunction with reference to FIG. 6, after computing the unrefined mask M_{b} 518, the next step is quantifying 418 an amount of detail present in at least one portion 612 of the second exposure image of the scene 514 that has a brightness level higher than the average brightness level of all pixels in the second exposure image of the scene 514, by applying a Laplacian to said second exposure image of the scene 614. Then, the next step is applying 420 a median blur denoising operation to form an intermediary Laplacian mask Mᵢ 616:

Mᵢ=Denoise(Laplacian(I_{d}))

for each region (R) in Mᵢ:
if Nᵣ<threshold
M_{b}[Nᵣ]=0

Where, Nᵣ is the number of non zero pixels in region R

Next is selecting 422 at least one pixel Nᵣ in at least one region R of the intermediary Laplacian mask Mᵢ 616 that does not have a zero value in comparison to the unrefined mask M_{b} 518, and then keeping only those common regions in the unrefined mask M_{b} 518 not having a zero value to form a refined mask M_{b} (Refined) 618. FIG. 6 illustrates the end result of applying the Laplacian 418, and the subsequent operations required to form a refined mask M_{b} (Refined) 618.

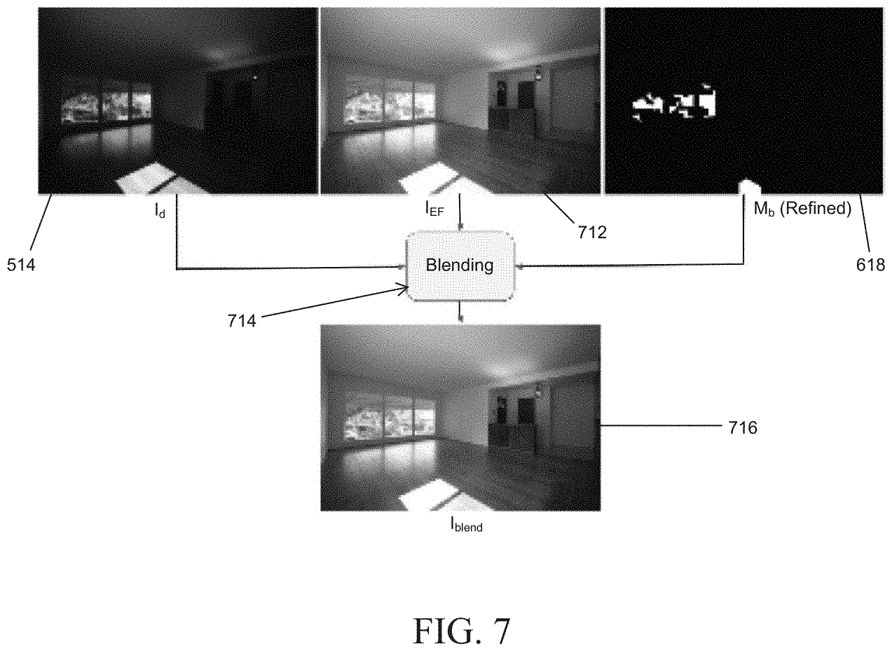

The final step in correcting detail obscured by brightness glare in an ‘interior’ image 410 is computing a blended image I_{blend} 716 (FIG. 7) by applying 424 a Gaussian pyramid operation and a Laplacian pyramid merging 714 (FIG. 7) of the darker (e.g. under-exposed) second exposure image I_{d} 514 and a simple Exposure Fusion image I_{EF} 712 (FIG. 7) formed from both the lighter 512 and darker 514 images, using the refined mask M_{b} (Refined) 618:

I_{blend}=Blend(I_{d},I_{EF},M_{b}(Refined))

The end result is a blended image I_{blend} 716 where the brightest regions of the darker (e.g. under-exposed) second exposure image I_{d} 514 bearing a greater amount of detail replace the overexposed regions in the simple Exposure Fusion image I_{EF} 712 that lack detail. FIG. 7 illustrates the final blending/merging step in the brightness correction method that results in a blended image I_{blend} 716.

In contrast to interior images, exterior image gamma tuning can be accurately determined based on the image's colorfulness. Colorfulness (C) is generally calculated in the following way:

C=stdRoot+(0.3*meanRoot)

Where,

stdRoot=√(std_{B}²+std_{YB}²)

meanRoot=√(mean_{B}²+mean_{YB}²)

YB=absolute(0.5*(R+G)−B)

where R,G,B are the RGB channels of the exterior image, and mean_{X} and std_{X} are mean and standard deviations of channel x, respectively.

In the context of exterior exposure fusion images I_{EF} and white-balanced images I_{WB}, Colorfulness is calculated on the exposure fusion result and the output of auto white balance on exposure fusion.

I_{WB}=WhiteBalance(I_{EF})

C1=Colorfulness(I_{EF})

C2=Colorfulness(I_{WB})

If (C1<1.03*C2):

I_{EF}=I_{WB}

The output is gamma corrected as follows:

for gamma in [0.5,0.6,0.7,0.8,0.9,1.0,1.1,1.2]:

I_{gamma}=GammaAdjustment(I_{EF})

if (maxMean_{gamma}>128) and (minMean_{gamma}>110):

I_{EF}=I_{gamma}

Where

maxMean_{gamma}=max(Mean(R_{gamma}),Mean(G_{gamma}),Mean(B_{gamma}))

minMean_{gamma}=min(Mean(R_{gamma}),Mean(G_{gamma}),Mean(B_{gamma}))

With a gamma-corrected (based on Colorfulness) exterior HDR composite image I_{gamma}, we are then able to correct over-brightened regions of the image that lost detail due to over exposure (as done above for interior images 410). The difference in the context of an exterior image is that gradient values are not used to filter out the over-exposed regions:

M_{d}=AND(INV(I_{d}),INV(I_{b}))

Where M_{d} is the mask of the darkest regions in the exterior scene. This darkness mask is then utilized in a blend to create a brightness-corrected and gamma-tuned HDR exterior image composite:

I_{ext blend}=Blend(I_{d},I_{gamma},M_{d})

After improving the visibility of details apparent in glare-obscured regions of a scene captured with HDR composite images, regions of that scene may need to be selected in their entirety for manipulation, correction, or wholesale replacement. In one embodiment of the present invention, the portion of an exterior image has such a region, such that segmentation and replacement of that portion can be performed to replace the overcast appearance within the final image to something else, or to manipulate the appearance of the existing region by increasing blue level or even enhancing contrast. In the present embodiment, the region for manipulation and/or replacement is an overcast sky.

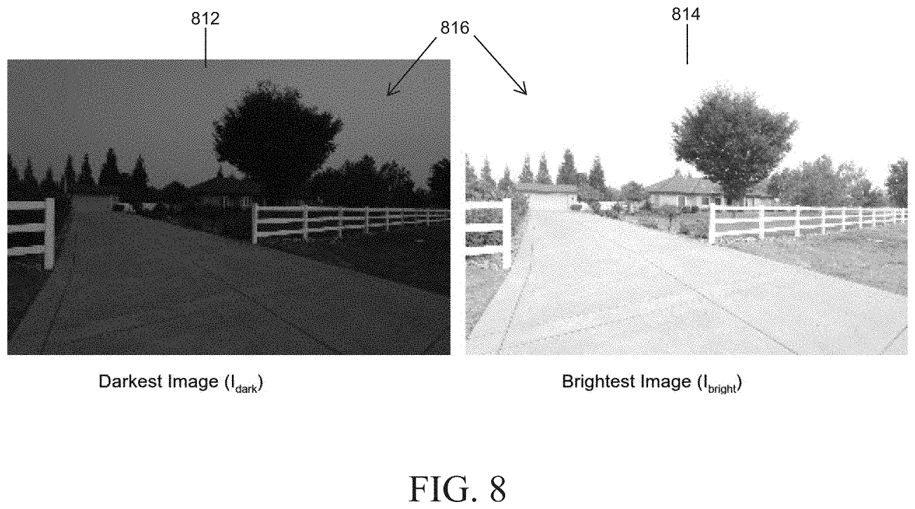

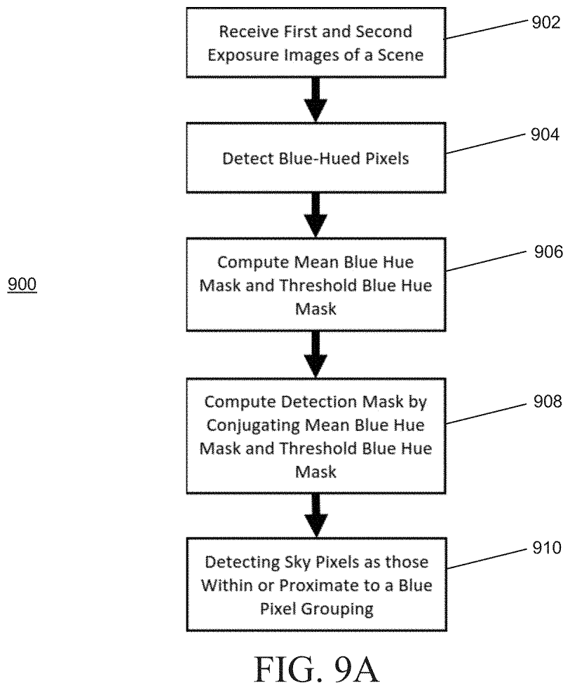

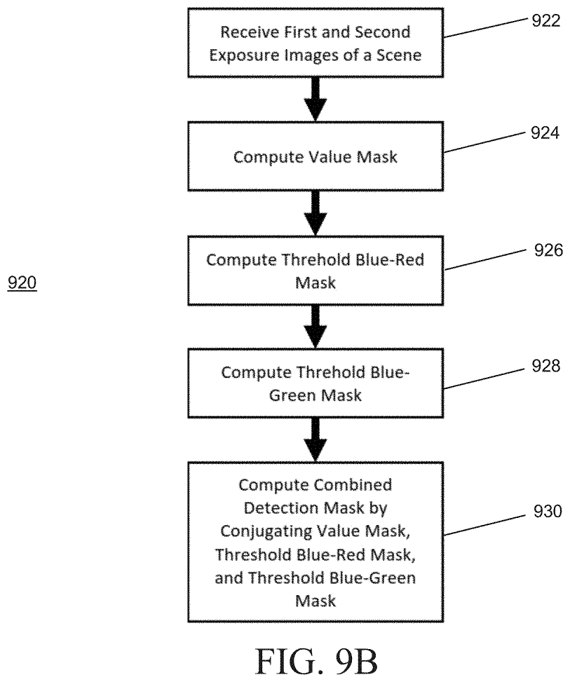

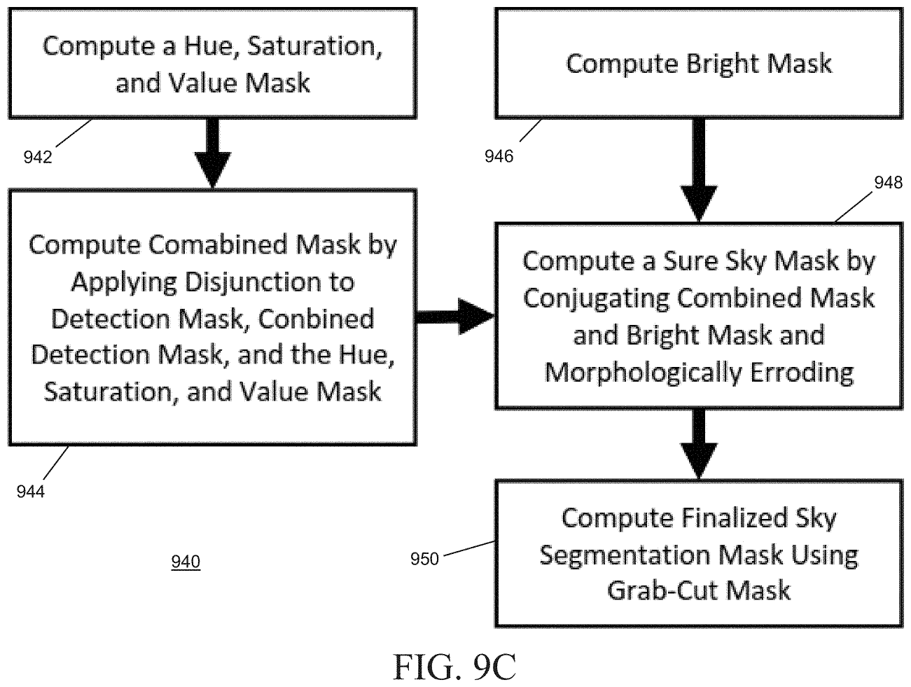

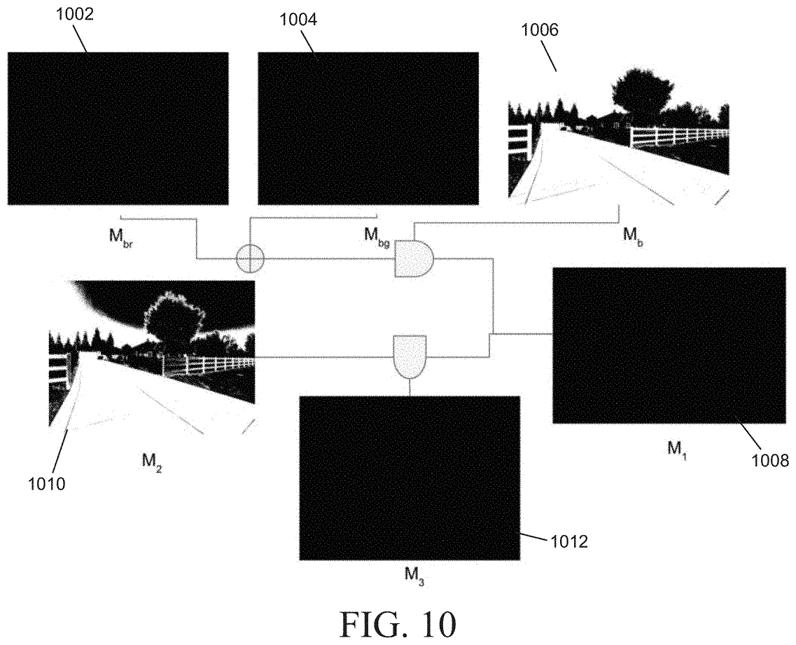

FIG. 8 shows two exterior images bearing extremes in exposure timing: a darkest exterior image I_{dark} 812 and a brightest exterior image I_{bright} 814. The portion of the images representing the overcast sky 816 must be detected and segmented before it can be replaced. Sky segmentation is mostly done on the darkest exterior image I_{dark} 812. Two heuristic approaches are used for segmenting the overcast sky region 816, thus creating two distinct masks (see FIGS. 9A & 9B) that are then finally combined to form a final segmentation mask (see FIG. 9C). FIGS. 10-14 illustrate the approaches captured by diagrammatic flowcharts of FIGS. 9A, 9B, & 9C.

FIG. 9A provides a diagrammatic flowchart of a first heuristic method 900 calculating a detection mask M₃1012 (FIG. 10) from the conjugation of a mean blue hue mask M₁ 1008 (FIG. 10) and a threshold blue hue mask M₂ 1010 (FIG. 10).

Ideally in the sky region 816 (FIG. 8) blue should outweigh red and green colorization. The blue tone value should also be greater than a certain threshold value. Therefore, we generate a mean blue hue mask M₁ 1008 (FIG. 10) through the conjugation of masks representing the detection of blue-hued pixels 904 as follows: (1) a blue-red comparative threshold mapping M_{BR} 1002 (FIG. 10); (2) a blue-green comparative threshold mapping M_{BG} 1004 (FIG. 10); and (3) a blue threshold mapping M_{B} 1006 (FIG. 10):

M_{BR}=(B−R)>th

M_{BG}=(B−G)>th

M_{B}=B>th

M₁=AND(OR(M_{BR},M_{BG}),M_{B})

A threshold blue hue mask M₂ 1010 (FIG. 10) is calculated when removing regions bearing oversaturation. The mean blue hue mask M₁ 1008 (FIG. 10) and the threshold blue hue mask M₂ 1010 (FIG. 10) are computed 906 together. The threshold blue hue mask M₂ 1010 (FIG. 10) can then be conjugated with the mean blue hue mask M₁ 1008 (FIG. 10) to calculate 908 a detection mask M₃1012 (FIG. 10):

meanB=mean(M₁*B)

M₂=B−meanB<th

M₃=AND(M₂,M₁)

The detection mask M₃ 1012 (FIG. 10) will likely include discrete disconnected (i.e. not adjacent to) blue-hue regions, which may come as a result of differentiation or separation by obscuring objects. To ensure that such smaller regions apart from the larger ‘sky’ region are not detected as ‘sky’ in the scene 910, we first detect a largest group of pixels R_{b} having a blue hue value greater than a predefined blue hue level threshold and then designate pixels away from the largest group of pixels R_{b} as non-sky:
Let R_{b} be the biggest region in the scene, and μ^{B}, μ^{G}, μ^{R} represent the means of region blue, green and red values in R_{b},
For each region r in M₃1012 (FIG. 10):

dist₁=L2-norm([μ^{B},μ^{G},μ^{R}],[Rmean^{r},Gmean^{r},Bmean^{r}])

if dist₁>th:

M₃{r}=0

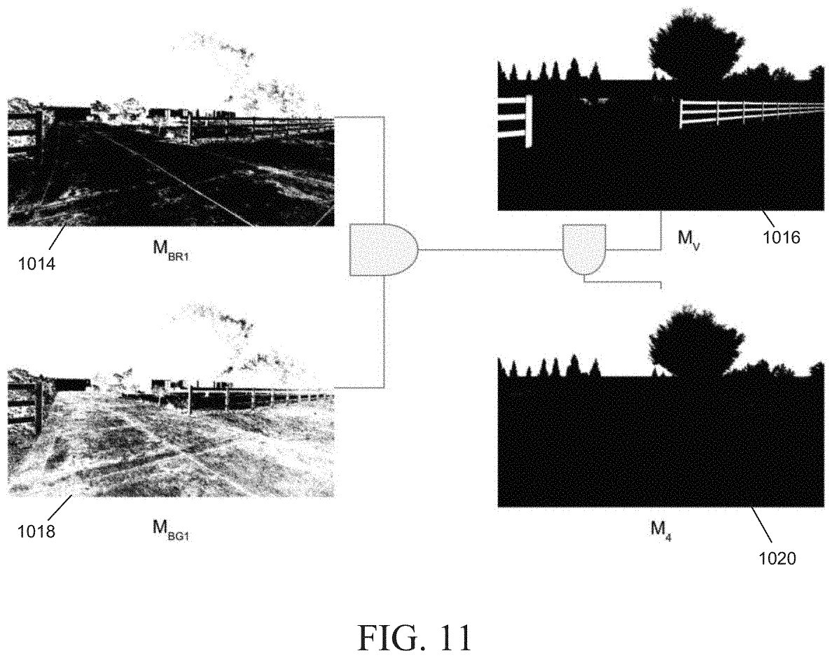

FIG. 9B provides a diagrammatic flowchart of a second heuristic method 920 calculating a combined detection mask M₄ 1020 (FIG. 11) by conjugating 930 a value mask M_{V} 1016 (FIG. 11), a threshold blue-red mask M_{BR1} 1014 (FIG. 11), and a threshold blue-green mask M_{BG1} 1018 (FIG. 11).

In the lowest (darkest) exposure image I_{dark} 812 (FIG. 8), the sky will be one of the brightest regions 816 (FIG. 8). If we assume the top 20% region of the scene is ‘sky,’ we can calculate the mean intensity channel of the image 812 and consider that it is close to the average brightness of the ‘sky’ therein. Similarly, the bottom 40% region of the image can be safely assumed to not be ‘sky’. The average brightness of that lower region can be assumed to be a sample of ‘non-sky’ regions in the image 812. Based on these averaged values, a value mask M_{V} 1016 (FIG. 11) is calculated 924, where V is the value channel:

sky_brightness=mean(V[0:0.2*image_h])

min_brightness=mean(V[0.6*image_h:image_h])

M_{V}[0:0.4*image_h]=V[0:0.4*image_h]>min(0.7*sky_brightness,t1)

M_{V}[0.4*image_h:]=V[0.4*image_h:]>min(2*min_brightness,t2)

if sky_brighntess<=t3:

M_{V}=AND(M_{V},V<245)

We then compute thresholded masks for the blue-red 926 and blue-green 928 channels to get masks for blue-red M_{BR1} 1014 (FIG. 11) and blue-green M_{BG1} 1018 (FIG. 11) channels:

M_{BR1}=B>R+10

M_{BG1}=B>G+10

Finally, the combined detection mask M₄1020 (FIG. 11) can be calculated as a conjugation of first the blue-red mask M_{BR1} 1014 (FIG. 11) and blue-green mask M_{BG1} 1018 (FIG. 11), and then a conjugation of that resultant with the value mask M_{V} 1016 (FIG. 11):

M₄=AND(AND(M_{BR1},M_{BG1}),M_{V})

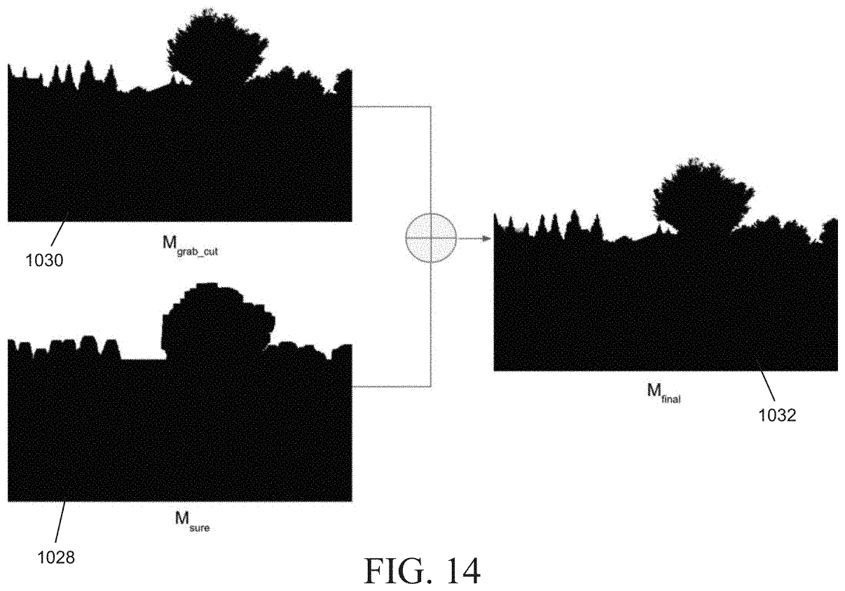

After completing the two heuristic approaches for detecting and differentiating (i.e. segmenting) the ‘sky’ region 816 (FIG. 8) apart from other pixel regions in the scene, we are left with two distinct masks (a detection mask M₃ 1012 (FIG. 10) and a combined detection mask M₄ 1020 (FIG. 11)) which can finally be combined 950 to form a final segmentation mask M_{final} 1032 (FIG. 14) that accurately distinguishes ‘sky’ from non-sky pixels within a scene.

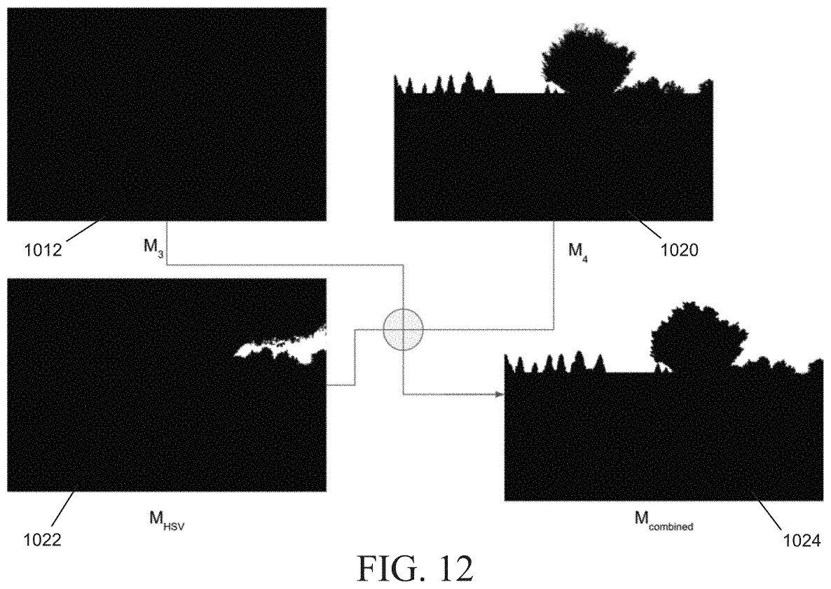

FIG. 9C provides a diagrammatic flowchart of a method 940 for calculating a final segmentation mask M_{final} 1032 (FIG. 14). As part of the final method 940, we must first compute 942 a hue, saturation, and value mask M_{HSV} 1022 (FIG. 12). Thresholds are applied on hue H, saturation S, and value V channels of the lowest exposure image I_{dark}812 (FIG. 8), and corresponding regions are detected on the resulting mask M_{HSV} 1022 (FIG. 12):

M_{HSV}=AND(S<t₁,AND(V>t₂,H<t₃))

Next, the newly-formed hue, saturation, and value mask M_{HSV} 1022 (FIG. 12) is merged 944 with the detection mask M₃1012 (FIG. 12) and a combined detection mask M₄1020 (FIG. 12) via disjunction to form a combined mask M_{combined} 1024 (FIG. 12) as follows:

M_{combined}=OR(M₃,M₄,M_{HSV})

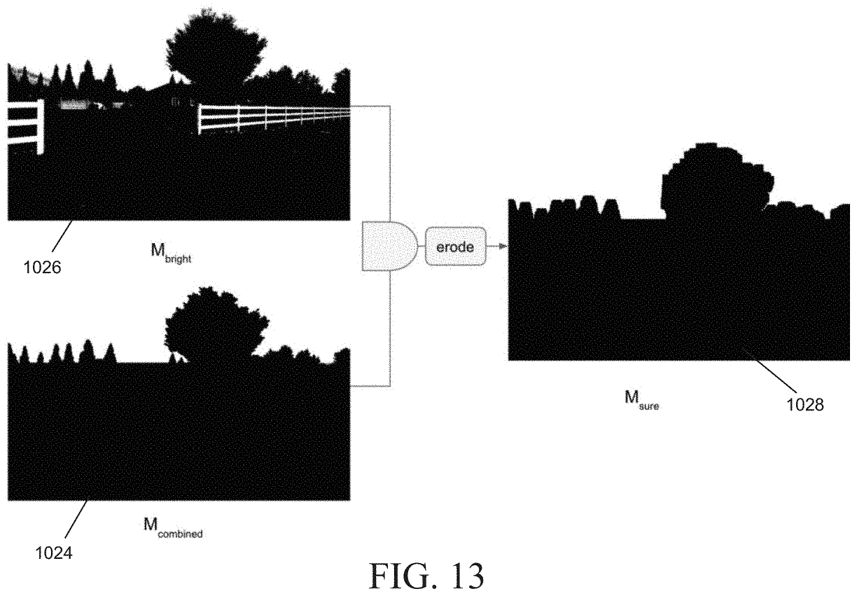

Next, a bright mask M_{bright} 1026 (FIG. 13) is computed 946 by conjugating the intensity—or luminocity—channel INT_{dark} of the darkest exterior image I_{dark} 812 (FIG. 8) and the intensity channel INT_{bright} of the brightest exterior image I_{bright} 814 (FIG. 8) and then thresholding the output to a predetermined brightness level t_{b}:

M_{bright}=AND(INT_{bright},INT_{dark})>t_{b}

Next, a sure sky mask Mₛᵤᵣₑ 1028 (FIG. 13) is computed 948 through the conjugation and morphological erosion of the previously-created combined mask combined mask M_{combined} 1024 (FIG. 13) and newly-created bright mask M_{bright} 1026 (FIG. 13):

Mₛᵤᵣₑ=(M_{combined}⊖M_{bright})

Next, an intermediary grab-cut mask M_{grab_cut} 1030 (FIG. 14) is computed as follows:

Mₛᵤᵣₑ=sure foreground seed

M_{combined}−Mₛᵤᵣₑ=probable foreground (M_{pf})

M_{sure_bg}=Bottom 40% region=sure background

INV(M_{sure_bg}+M_{combined})=probable background

M_{grab_cut}=GRAB_CUT(Mₛᵤᵣₑ,M_{pf},M_{sure_bg},INV(M_{sure_bg}+M_{combined}))

Finally, the newly-created intermediary grab-cut mask M_{grab_cut} 1030 (FIG. 14) is merged via disjunction with the sure sky mask Mₛᵤᵣₑ 1028 (FIG. 14) to compute 950 the finalized sky segmentation mask M_{final} 1032 (FIG. 14) as follows:

M_{final}=OR(M_{grab_cut},Mₛᵤᵣₑ)

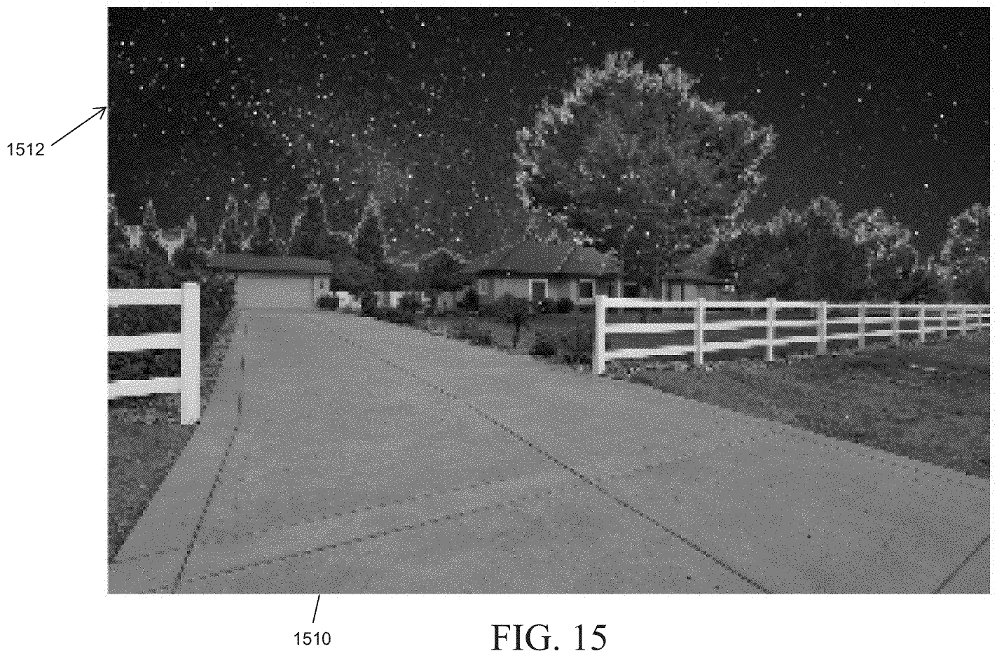

In this embodiment, the creation of the finalized sky segmentation mask M_{final}1032 (FIG. 14) allows for the easy detection and subsequent replacement of the portion of the scene that is ‘sky’. FIG. 15 shows an HDR-merged exterior image 1510 combined from a darkest exterior image I_{dark} 812 (FIG. 8) and a brightest exterior image I_{bright} 814 (FIG. 8), wherein the portion of the images previously representing the overcast sky 816 (FIG. 8) has been automatically and completely replaced by the image of a starry sky 1512 via segmentation per a finalized sky segmentation mask M_{final} 1032 (FIG. 14) of the bounded ‘sky’ region and application of alpha blending of an underlying replacement image. In an alternative embodiment, the methods discussed herein (900, 920, and 940) for accurate segmentation of an image can be applied to other regions of a scene and need not be used only to segment sky. Variations in thresholding for colorization values and assumptions regarding placement of the segmentation region within the scene allow for segmentation of a variety of features and/or portions of indoor and outdoor scenes (e.g. rectangular real estate signboards, ceilings, lawns, pools, carpets, etc.). The only constraint on variations in embodiments that can be considered as part of the present invention is that the image portion or pixel region being subjected to segmentation must be detectable and different in comparison to other pixel groupings within the same scene.

The segmentation improvement method described in the present embodiment also affords improvement in pretraining convolutional networks of artificial neurons through the repeated convolution and pooling of at least one set of clear sky images and at least one set of sky images at least partially containing cloud cover. In an alternative embodiment, clear-sky and cloud-cover images may be synthetically generated using computer graphics. In a further alternative embodiment, the improvements in pretraining can be applied to features and/or portions of indoor and outdoor scenes other than the sky (e.g. rectangular real estate signboards, ceilings, lawns, pools, carpets, etc.).

While the invention herein disclosed has been described by means of specific embodiments and applications thereof, numerous modifications and variations could be made thereto by those skilled in the art without departing from the scope of the invention set forth in the claims.

What is claimed is:

1. A method of determining gamma correction in an image, comprising:
receiving, by one or more processors, at least a first exposure image of a scene;
receiving, by the one or more processors, at least a second exposure image of the scene, wherein the second exposure image of the scene has a shorter exposure time than the first exposure image of the scene;
computing, by the one or more processors, a pixel value for a pixel location of a high dynamic range (HDR) image to be a sum of a pixel value of the first exposure image weighted by a first exposure weight and a pixel value of the second exposure image weighted by a second exposure weight, to produce a merged HDR image comprising Y bit data;
adaptively mapping, by the one or more processors, the HDR image, to produce an output HDR image having Z bit data and a total number of pixels;
applying, by the one or more processors, a range of gamma value correction levels to the output HDR image;
detecting a number of pixels having a value of black level less than a predefined black level threshold; and
selecting a tuned gamma value correction level.

2. The method of claim 1, further comprising:
When selecting a tuned gamma value correction level, said number of pixels having a value of black level less than a predefined black level threshold is less than 0.025*(said total number of pixels).

3. A method of correcting detail obscured by brightness glare in an image, comprising:
receiving, by one or more processors, at least a first exposure image of a scene;
receiving, by the one or more processors, at least a second exposure image of the scene, wherein the second exposure image of the scene has a shorter exposure time than the first exposure image of the scene;
computing, by the one or more processors, a refined mask, by
performing a conjugation of the at least first exposure image of the scene and the at least second exposure image of the scene and selecting a number of pixels having a value of black level greater than a predefined black level threshold to form an unrefined mask of the scene,
quantifying an amount of detail present in at least one portion of the second exposure image of the scene having a brightness level higher than the average brightness level of all pixels in the second exposure image of the scene, by applying a Laplacian to said second exposure image of the scene and applying a median blur denoising operation to form an intermediary laplacian mask, and
selecting at least one pixel in at least one region of the intermediary laplacian mask that does not have a zero value; and
computing a blended image by applying a gaussian pyramid operation and a laplacian pyramid merging of the at least second exposure image and an exposure fusion image using the refined mask.

4. A method of segmenting an image having sky by computing a pixel mask, comprising:
receiving, by one or more processors, at least a first exposure image of a scene;
receiving, by the one or more processors, at least a second exposure image of the scene, wherein the at least second exposure image of the scene has a shorter exposure time than the at least first exposure image of the scene;
detecting, a number of pixels having a blue hue value greater than a predefined blue hue level threshold, greater than a red hue value for the number of pixels, and greater than a green hue value for the number of pixels;
computing, by one or more processors, a detection mask by conjugating at least one mean blue hue mask and at least one threshold blue hue mask; and
computing, by one or more processors, at least one group of pixels from the detection mask as sky, by detecting a largest group of pixels having a blue hue value greater than a predefined blue hue level threshold, greater than a red hue value for the number of pixels in the detection mask, and greater than a green hue value for the number of pixels in the detection mask, and designating pixels away from said largest group of pixels as not sky.

5. The method of claim 4, further comprising:
computing, by one or more processors, a value mask by averaging the brightness value of the at least one group of pixels in a value channel;
computing, by one or more processors, a threshold blue-red mask by detecting at least one pixel having a blue hue value greater than a predefined red hue level threshold;
computing, by one or more processors, a threshold blue-green mask by detecting at least one pixel having a blue hue value greater than a predefined red hue level threshold;
computing, by one or more processors, a combined detection mask by conjugating the threshold blue-red mask, threshold blue-green mask, and the value mask;
computing, by one or more processors, a hue, saturation, and value mask by conjugating a hue threshold, a saturation threshold, and a value threshold of the at least one group of pixels of the at least second exposure image of the scene;
computing, by one or more processors, a combined mask by applying a disjunction to the detection mask, combined detection mask, and hue, saturation, and value mask;
computing, by one or more processors, a bright mask by conjugating at least a brightest intensity channel of the at least first exposure image of the scene and a brightest intensity channel of the at least second exposure image of the scene and retaining portions exceeding a defined brightness threshold;
computing, by one or more processors, a sure sky mask by conjugating the combined mask and the bright mask and subsequently applying a morphological erosion;
computing, by one or more processors, a finalized sky segmentation mask by calculating a probable foreground segment mask, calculating a probable background segment mask, iteratively segmenting a conjunction of the sure sky mask, the probable foreground segment mask, and the probable background segment mask to form a grab cut mask, and applying a disjunction to the grab cut mask and sure sky mask.

6. A method of classifying, segmenting, and replacing the sky in an image scene, comprising:
classifying at least one group of pixels in an image scene as a sky portion by inputting a digitized image into a convolutional network of artificial neurons pretrained through the repeated convolution and pooling of at least one set of clear sky images and at least one set of sky images at least partially containing cloud cover;
computing a pixel mask bounding the sky portion, wherein the pixel mask is calculated from the collection and convolution of at least a first exposure image of a scene and at least a second exposure image of the scene, wherein the at least second exposure image of the scene has a shorter exposure time than the at least first exposure image of the scene; and
replacing the sky portion bounded by the pixel mask.

7. The method of claim 6, wherein replacing the sky portion bounded by the pixel mask occurs by applying a segmented interpolation.

8. The method of claim 6, wherein replacing the sky portion bounded by the pixel mask occurs by applying alpha blending to a whole-image replacement.

9. A method of classifying, segmenting, and replacing at least one portion of an image scene, comprising:
classifying at least one group of pixels in an image scene as a relevant portion by inputting a digitized image into a convolutional network of artificial neurons pretrained through the repeated convolution and pooling of at least one image set containing at least one training replacement portion;
computing a pixel mask bounding the relevant portion and calculated from the collection and convolution of at least a first exposure image of a scene and at least a second exposure image of the scene, wherein the at least second exposure image of the scene has a shorter exposure time than the at least first exposure image of the scene; and replacing the relevant portion of bounded by the pixel mask.

10. The method of claim 9, wherein replacing the relevant portion bounded by the pixel mask occurs by applying a segmented interpolation.

11. The method of claim 9, wherein replacing the relevant portion bounded by the pixel mask occurs by applying alpha blending to a whole-image replacement.
